(19) United States
(12) Patent Application Publication
(10) Pub. No.: US 2026/0167094 A1
(43) Pub. Date: Jun. 18, 2026

(54) ARRANGEMENT FOR A VEHICLE ROOF HAVING A MOVABLE ROOF COVER AND LIGHTING, AND ASSOCIATED PRODUCTION METHOD

(71) Applicant: Webasto SE, Stockdorf (DE)

(72) Inventors: Michael STEIGTHALER, Stockdorf (DE); Maximilian FISHER, Stockdorf (DE); Milan MATOK, Stockdorf (DE)

(21) Appl. No.: 19/133,341

(22) PCT Filed: Nov. 23, 2023
(86) PCT No.: PCT/EP2023/082809

§ 371 Date: May 28, 2025

(30) Foreign Application Priority Data
Nov. 29, 2022 (DE) 10 2022 131 551.7

(51) Int. Cl. B60Q 1/24; B60J 7/04; B60Q 1/00

(52) U.S. Cl. CPC B60Q 1/24; B60J 7/04; B60Q 1/0076

(57) ABSTRACT

An arrangement for a vehicle roof has a cover having a lighting arrangement, the cover designed to form a movable roof element in the vehicle roof. The arrangement also has a foam material which is formed on the cover. The arrangement also has a magnetic element and a magnetic sensor which are designed to cooperate with one another. One of the magnetic element and the magnetic sensor is embedded in the foam material of the cover. The other of the magnetic element and the magnetic sensor is intended to be arranged on a stationary roof element of the vehicle roof such that a movement of the cover relative to the stationary roof element is able to be detected by the magnetic sensor and the lighting arrangement of the cover is actuable depending on the detected movement.

### CROSS-REFERENCE TO RELATED APPLICATIONS

This application is a U.S. national phase application filed under 35 U.S.C. §371 of International Application No.

PCT/EP 2023/082809, filed on Nov. 23, 2023, published under WO 2024/115260 A1 on Jun. 6, 2024, designating the United States, which claims priority from German Patent Application Number 10 2022 131 551.7, filed on Nov. 29, 2022, which are hereby incorporated herein by reference in their entirety.

### FIELD

The invention relates to an assembly for a vehicle roof, and to a vehicle roof for a motor vehicle comprising such an assembly. The invention furthermore relates to a method for producing such an assembly for a vehicle roof.

### BACKGROUND

Some motor vehicles have an assembly with a roof or cover element that allows a view through the latter and can open or close a roof opening as desired. Moreover, such roof elements can be provided with a lighting function. It is always a challenge to enable a reliable and safe operation of the interacting components and functionalities.

### SUMMARY

The invention is based on the object of contributing in a cost-effective manner to a reliable and safe operation of an assembly for a vehicle roof.

The object is achieved by the respective features of the independent patent claims. Advantageous refinements are set forth in the associated dependent patent claims.

An assembly according to the invention for a vehicle roof comprises a cover having a lighting assembly, which is designed to form a movable roof element in the vehicle roof. The assembly furthermore comprises a foaming which is formed on the cover. The assembly furthermore comprises a magnetic element and a magnetic sensor, which are configured to interact with one another. The magnetic sensor is suitable for measuring magnetic fields so as to detect the magnetic field of the magnetic element at a specific spacing. One of magnetic element and magnetic sensor is embedded within the foaming of the cover. The other of magnetic element and magnetic sensor is accordingly configured to be disposed on a stationary roof element of the vehicle roof in such a way that a movement of the cover relative to the stationary roof element is detectable by means of the magnetic sensor. The lighting assembly of the cover is actuatable as a function of the detected movement.

By means of the described assembly, a roof system having lighting assembly, which can be produced cost-effectively and which can contribute to a reliable and safe operation of the assembly for a vehicle roof, is able to be implemented. For example, the magnetic element is implemented as a ferromagnetic permanent magnet and is enclosed in the foaming and thus not in the field of view of a vehicle occupant of an associated motor vehicle. Alternatively, the magnetic sensor may be surrounded by the foaming of the cover.

The magnetic element or the magnetic sensor can be embedded within the foaming of the cover in such a way that the foaming completely or only partially surrounds the magnetic element or the magnetic sensor. Partially surrounded means that the magnetic element or the magnetic sensor is surrounded in such a way that the magnetic element or the magnetic sensor is surrounded by the foaming to the extent of at least 50%, preferably at least 70%, and/or on at least two sides and/or on at least two surfaces.

In one embodiment, the foaming has a clearance which is designed to receive the one of magnetic element or magnetic sensor. For example, the clearance is positioned correspondingly to the other of magnetic sensor or magnetic element on the stationary roof element. Preferably, the one of magnetic sensor or magnetic element is inserted in the clearance. In one design embodiment, the magnetic sensor or the magnetic element can be disposed in the clearance by means of a force-fit, for example by means of a clamping connection, by means of a materially integral fit, for example by means of an adhesive connection, and/or by means of a form-fit, preferably by means of a combination of at least two of the above. In this way, the assembly is particularly cost-effective to produce, and allows for interchangeability of the magnetic sensor or the magnetic element as well as easy calibration.

The magnetic sensor is designed in particular as a Hall sensor, or comprises such a sensor. In the description hereunder, the assembly is predominantly described in the context of a Hall sensor, but the described properties and features are also transferable to the assembly with a magnetic sensor which is not necessarily implemented as a Hall sensor.

According to a refinement of the assembly, the cover in terms of a vehicle longitudinal axis is configured to form a front roof element in the vehicle roof. The stationary roof element in terms of the vehicle longitudinal axis is configured to form a rear roof element in the vehicle roof. The magnetic element or Hall sensor is disposed on a rear edge of the cover, or is configured to be disposed on a leading edge of the stationary roof element.

For the purposes of this description, terms such as “top”, “bottom”, “front”, “rear”, “left”, “right”, and “vertical” and “horizontal” relate to directions, orientations or alignments as given in an operationally ready motor vehicle. The cover usually forms an upper part of the motor vehicle and can, for example, be tilted at the rear and opened toward the rear. Here, guide elements in the form of guide rails, which enable a reliable movement of the cover, can be disposed laterally on the left and right on or in the vehicle roof.

According to a refinement of the assembly, one of magnetic element and Hall sensor is configured to be disposed on a roof bodywork. The roof bodywork implements a possibility for a stationary roof element, so that a relative movement of the cover and the roof bodywork is able to be carried out. The magnetic element or Hall sensor is preferably able to be coupled interchangeably with the roof body, so that a simple and safe replacement is possible if required.

The stationary roof element does not necessarily form a component of the described assembly, but rather a component of a system, for example in the form of a vehicle roof. The magnetic element or Hall sensor is always configured to be coupled to the stationary roof element. For example, the magnetic element or the Hall sensor comprises a coupling element or a coupling structure which is configured in a predefined manner so as to be adapted to the respective stationary roof element. The stationary roof element is stationary and not movable in comparison to other components of the motor vehicle, such as windows or a body. The cover, on the other hand, is designed to be movable.

According to a further refinement of the assembly, the magnetic element or the Hall sensor is configured to be disposed on a guide rail for the vehicle roof. The guide rail can implement an additional stationary roof element which is not movable in comparison to the cover. In each case, however, a relative movement of the cover and the stationary roof element is provided in relation to an installed and operationally ready state in the vehicle roof of a motor vehicle.

According to a further refinement of the assembly, the magnetic element or the Hall sensor within the foaming of the cover is disposed on a cover inner panel. Thus, the respective element can be positioned in its position within the foaming in a simple manner, moreover utilizing the cover inner panel, which is usually provided for reinforcing the cover, as a coupling element.

According to a further refinement of the assembly, the cover has a position indication element which indicates a position of the magnetic element or the Hall sensor in the foaming of the cover. Such a position symbol makes it easy to check the presence of the magnetic element or Hall sensor in the foaming, or to locate the position of the magnetic element or Hall sensor in the foaming.

A vehicle roof according to the invention for a motor vehicle comprises a stationary roof element which forms a roof bodywork of the vehicle roof or which, for example as an additional cover, as a blackout device, as a fixed glass component or as a guide rail, is coupled to a roof bodywork of the vehicle roof. The vehicle roof also comprises a design embodiment of the above-described assembly, which is coupled to the stationary roof element, wherein the cover is configured to close a roof opening in the vehicle roof in a predefined manner, or to expose the latter when required. One of magnetic element and Hall sensor within the foaming is coupled to the cover, and the other of magnetic element and Hall sensor is coupled to the stationary roof element.

Owing to the fact that the vehicle roof comprises a design embodiment of the above-described assembly, the features and properties of the assembly are also disclosed in terms of the vehicle roof and vice versa. For example, the cover is implemented as a front openable roof element in front of the stationary rear roof element. For example, the magnetic element can be foamed on a rear edge of the front roof element, and the Hall sensor can be disposed on a front edge of the rear roof element. For example, the rear roof element also has a foaming with one or more coupling openings. The Hall sensor comprises, for example, a bracket having a coupling element which is configured to be incorporated into the coupling opening of the foaming of the rear roof element. This means that the Hall sensor can be interchangeably coupled with the stationary roof element. A correspondingly alternative embodiment in which the magnetic element can be interchangeably coupled with the stationary roof element, and the Hall sensor is integrated in the foaming of the cover, is likewise possible.

A method according to the invention for producing an assembly for a vehicle roof comprises: providing a cover having a lighting assembly, which is configured to form a movable roof element in the vehicle roof. The method furthermore comprises: providing a magnetic element and a Hall sensor, which are configured to interact with one another, wherein one of magnetic element and Hall sensor is configured to be foamed and coupled to the cover, and the other of magnetic element and Hall sensor is configured to be coupled to a stationary roof element of the vehicle roof. The method furthermore comprises positioning one of magnetic element and Hall sensor relative to the cover, and forming a foaming on the cover in such a way that one of magnetic element and Hall sensor is embedded in the foaming. Thus, a movement of the cover relative to the stationary roof element is detectable by means of the Hall sensor, and the lighting assembly of the cover is actuatable as a function of the detected movement.

Owing to the fact that the method allows producing a design embodiment of the above-described assembly, previously described features and properties of the assembly are also disclosed for the manufacturing process and vice versa.

According to a refinement, the method comprises providing the stationary roof element, which forms a roof bodywork of the vehicle roof or is configured to be coupled to a roof bodywork of the vehicle roof. Accordingly, the method further comprises coupling the other of magnetic element and Hall sensor, which is not integrated in the foaming of the cover, to the stationary roof element.

Forming the foaming on the cover can furthermore comprise providing a foaming tool having a sensor. The sensor is configured to be able to detect the presence of the magnetic element within a predefined spaced-apart region. Preferably, the magnetic element is provided to be integrated in the foaming of the cover, so that the method can accordingly comprise positioning of the magnetic element relative to the cover. According to such an embodiment, the method furthermore comprises determining the presence of the magnetic element by means of the sensor of the foaming tool, and foaming of the magnetic element and foaming of the cover as a function of the detected presence of the magnetic element.

According to a further refinement of the method, the positioning of the magnetic element relative to the cover can comprise providing a cover inner panel for the cover. The method furthermore comprises disposing the magnetic element at a predetermined position on the cover inner panel, and positioning the cover inner panel with the magnetic element relative to the cover.

Alternatively or additionally, the positioning of the magnetic element relative to the cover can comprise providing a cover inner panel for the cover and incorporating the magnetic element into the foaming tool at a predefined position. The method accordingly furthermore comprises incorporating the cover inner panel into the foaming tool, and moving the cover inner panel to the magnetic element and self-positioning the magnetic element on the cover inner panel as a function of a magnetic force of the magnetic element. Thereafter, the cover inner panel with the magnetic element can be positioned relative to the cover.

Openable roof systems with a lighting function, in which, for example, light is guided in a glass cover, must not be illuminated in certain situations or positions, such as when open, due to statutory safety regulations. Accordingly, it is necessary to reliably deactivate the lighting function when the roof element provided therewith is opened. It is a finding in connection with the present invention that conventional concepts have a relatively large installation space requirement and/or components for switching off a lighting function are in the field of view of vehicle occupants. In addition, in conventional concepts some components are installed in such a way that the entire roof system may have to be removed and serviced in the event of a defect.

By means of the described assembly, a roof system with lighting assembly, which can be cost-effectively manufactured and maintained and which can also contribute to a reliable and safe operation of the assembly with lighting function for a vehicle roof, can be implemented. The assembly allows information pertaining to a current cover position to be provided. Preferably, the magnetic element is fixed as a magnetic component on a cover inner panel by its own magnetic action before a foaming process and subsequently foamed. A position of the magnet can be specified usefully by means of corresponding markings on or at the cover inner panel. In order to prevent incorrect installation, a separate sensor in the foaming tool can register whether the magnet is present at the specified location or not. If it has been detected that the magnet is present, the subsequent process step of foaming can be released.

The magnetic element can be a permanent ferromagnetic, diamagnetic or paramagnetic magnet. Alternatively, an actuatable solenoid can also be provided as a magnetic element. For example, the magnet is inserted into a non-ferromagnetic insert of the foaming tool, and a sensor in the foaming tool registers whether the magnet is inserted as predefined. This can prevent an incorrect installation of the magnet or detect that the insertion of a magnet might have been forgotten. When one or a plurality of cover inner panels are inserted into the foaming tool, the magnet per se positions itself relative to the cover inner panel via its ferromagnetic action. After closing the foaming tool, the entire assembly, including a glass or glass element of the cover, can be foamed as predefined. Thus, the assembly for the vehicle roof can be designed with a space-saving and clearly arranged structure, without the magnetic element being in a field of view of a vehicle occupant.

### BRIEF DESCRIPTIONS OF THE DRAWINGS

Exemplary embodiments of the invention are explained in more detail below with reference to the schematic drawings. In the drawings:

FIG. 1 shows a schematic illustration of a vehicle roof for a motor vehicle, in a perspective view;

FIG. 2 shows an exemplary embodiment of an assembly for the vehicle roof in a schematic sectional illustration;

FIG. 3 shows a flowchart for a method for producing the assembly according to FIG. 2 for the vehicle roof; and

FIGS. 4-5 show further exemplary embodiments of the assembly for the vehicle roof in a respective schematic Sectional illustration.

Elements of identical construction or function are identified with the same reference signs in all the figures. For reasons of clarity, it is possible that not all of the elements shown are identified with reference signs in all of the figures.

### DETAILED DESCRIPTION

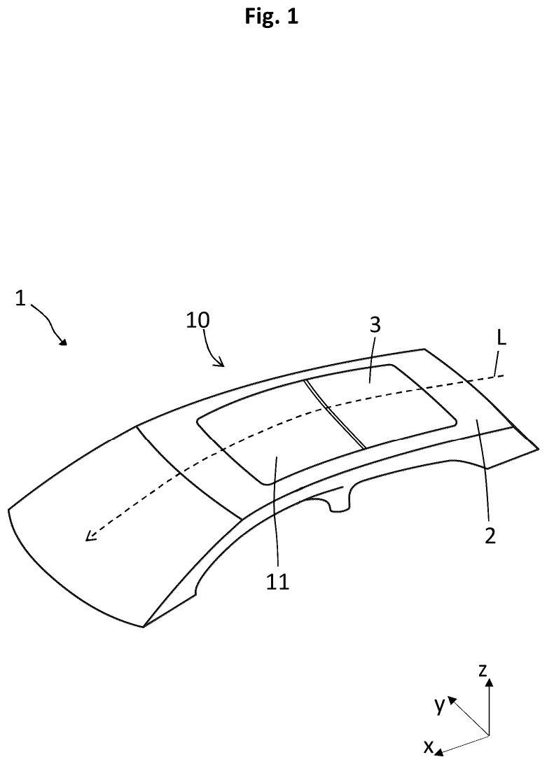

FIG. 1 schematically shows in a perspective view a vehicle roof 1 for a motor vehicle, which has a roof bodywork 2 and an assembly 10 comprising a cover 11 having a lighting assembly 21, and is coupled to the roof bodywork 2. The cover 11 is designed as a front openable roof element and movable relative to the vehicle roof 1, in order to selectively expose or close an opening in the vehicle roof 1. The vehicle roof 1 furthermore comprises a rear stationary roof element which is designed, for example, as a stationary fixed glass element 3 and is coupled to the roof bodywork 2.

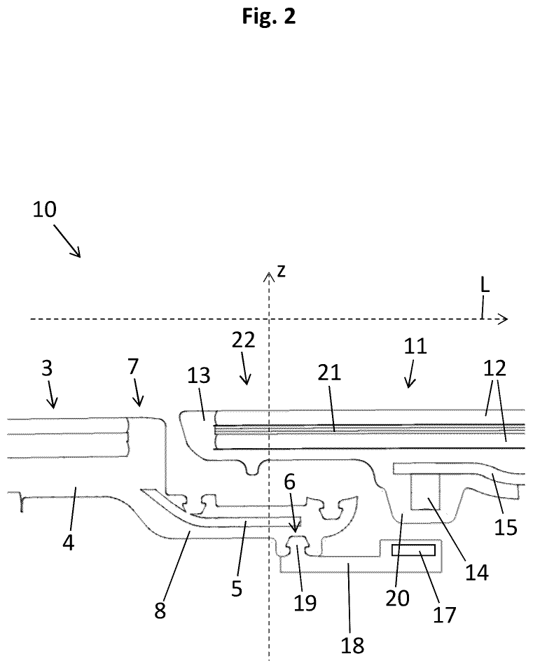

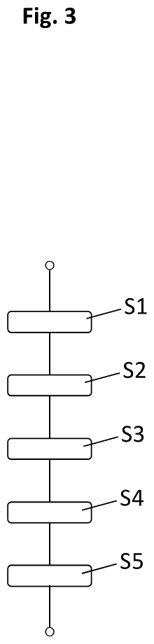

As is explained in more detail with reference to the following FIGS. 2-3, a roof system which is cost-effective to manufacture, can be maintained in a time and cost-saving manner and also enables reliable and safe operation of the lighting assembly 21 of the cover 11, can be implemented by means of the assembly 10.

FIG. 2 shows a schematic sectional illustration of the vehicle roof 1 according to FIG. 1 along a plane which is predefined, for example, by a vertical z-direction and a vehicle longitudinal axis L. For the purposes of this description, terms such as “top”, “bottom”, “front”, “rear”, “left”, “right” and “vertical” and “horizontal” refer to directions, orientations or alignments such as those given in an operationally ready motor vehicle according to FIG. 1. The cover 11 in terms of the longitudinal axis of the vehicle L is accordingly disposed in front of the fixed glass element 3. The illustrated arrow symbols of the z-direction and the longitudinal axis of the vehicle L indicate an upward direction or a normal direction of travel.

The assembly 10 comprises a foaming 13, which is formed on a rear edge 22 of the cover 11. The cover 11 comprises two glass elements 12, between which the lighting assembly 21 is disposed. The assembly 10 also comprises a magnetic element 14 and a Hall sensor 17, which are configured to interact with one another.

The magnetic element 14 is disposed on a cover inner panel 15 and embedded in the foaming 13 of the cover 11. The foaming 13 covers an edge of the cover 11, which faces the fixed glass element 3, and a portion on a lower side of the cover 11, which faces a vehicle interior. The foaming 13 has a protrusion 20 into which the magnetic element 14 is integrated. Preferably, the foaming 13 is formed mirror symmetrically with respect to the longitudinal axis of the vehicle L, so that a corresponding protrusion of a foaming is likewise designed on the opposite side of the vehicle roof 1. However, there is no need for another magnetic element or another Hall sensor on the opposite side. However, an additional magnetic element and/or a further Hall sensor may optionally be provided. The opposite foaming can form a separate foaming or form a portion of the foaming 13, which is designed, for example, in an encircling manner on the periphery of the cover 11 and implements a kind of foaming frame.

The Hall sensor 17 of the assembly 10 is disposed on the stationary fixed glass element 3, or coupled to the latter.

Formed on a front edge 7 of the fixed glass element 3, which faces the cover 11, is a foaming 4 which has a protrusion 8 extending forward in the direction of the cover 11. The foaming 4 of the fixed glass element 3 extends to below the cover 11, into the region of the protrusion 20 of the foaming 13 of the cover 11, and thus into the region of the magnetic element 14. A reinforcement element 5 is conjointly foamed within the foaming 4 of the fixed glass element 3. The foaming 4 of the fixed glass element 3 has at least one coupling opening 6 in which engages a corresponding coupling element 19 that is formed on a sensor bracket 18 comprising the Hall sensor 17. In this way, the Hall sensor 17 can be easily and reliably replaced if required and a new Hall sensor 17 can be clipped in, for example in the event of damage.

The Hall sensor 17 and the magnetic element 14 as well as an intervening spacing are configured so as to be mutually adapted. The magnetic element 14 is selected in particular in such a way that it withstands the foaming process for forming the foaming 13 of the cover 11. The foaming process is carried out, for example, at a temperature of more than 100° C., so that this can be taken into account when embedding the magnetic element 14 in the foam. With regard to its magnetic properties, the magnetic element 14 is selected in such a way that it enables reliable detection by means of the Hall sensor 17 after the foaming process.

FIG. 2 shows substantially a closed position of the cover 11, in which the magnetic element 14 and the Hall sensor 17 are disposed relatively close to one another. By means of the Hall sensor 17 and the magnetic element 14 embedded in the foam, a movement of the cover 11 relative to the stationary fixed glass element 3 can be detected and then the lighting assembly of the cover 11 can be activated or deactivated, depending on whether the cover 11 is closed or opened. When the cover 11: is opened, the cover 11 is positioned, for example, at the rear or at the rear edge 22 and, if necessary, moved backward over the fixed glass element 3. When the cover 11 is opened, the magnetic element 14 is removed from the stationary Hall sensor 17, so that it is detected that the magnetic element 14 is no longer located near the Hall sensor 17. The lighting assembly 21 of the cover 11 can then be deactivated if switched on.

The Hall sensor 17, for example, is electrically connected to a control unit of the motor vehicle or is coupled by signal technology and sends a measuring signal to the control unit, on the basis of which it can be determined whether or not the magnetic element 14 is present at a predetermined spacing, and thus whether the cover 11 is closed or not. If it is determined that the cover 11 is opened and thereby the magnetic element 14 is removed from the Hall sensor 17, the control unit can send a control command to the lighting assembly 21, which deactivates it and, for example, switches off a current.

A method for producing the assembly 10 according to FIG. 2 can be carried out according to the flowchart in FIG. 3 as follows. In a step S1, the cover 11 with the glass elements 12 and the lighting assembly 21 is provided.

In a step S2, the magnetic element 14 and the Hall sensor 17 are provided with predefined properties.

In a step S3, the magnetic element 14 is inserted into a non-ferromagnetic insert of a foaming tool. The foaming tool comprises a sensor that registers whether the magnetic element 14 is inserted as predefined. Thus, an incorrect installation of the magnetic element 14 can be prevented or detected, or it is determined that no magnetic element 14 has been inserted so far. The cover inner panel 15 is disposed conjointly with the magnetic element 14 in a predefined position relative to the cover 11.

In a step S4, the cover inner panel 15 can be inserted into the foaming tool and brought to the magnetic element 14, so that from a certain distance, the magnetic element 14 is positioned itself on the cover inner panel 15 due to its magnetic action. As an alternative to steps S3 and S4, the magnetic element 14 can also be disposed directly on the cover inner panel 15 and provided for the foaming process.

The sensor of the foaming tool can register before the foaming process whether the cover inner panel 15 is prepared with the magnetic element 14. The cover inner panel 15 is disposed conjointly with the magnetic element 14 in a predefined position relative to the cover 11. The sensor of the foaming tool can be implemented as a magnetic sensor and/or as a mechanical sensor, which implements an aid, for example in the form of a spring-loaded pin element, and, for querying the position of the magnetic element 14 before the foaming, detects whether or not the magnetic element 14 is disposed as predefined.

In a further step S5, the foaming of the cover 11, the magnetic element 14 and the cover inner plate 15 is then carried out, provided that it was detected that the magnetic element 14 is positioned as predefined and the foaming process is released. Thus, the foaming 13, for example of polyurethane, in which the magnetic element 14 is reliably and safely embedded is formed.

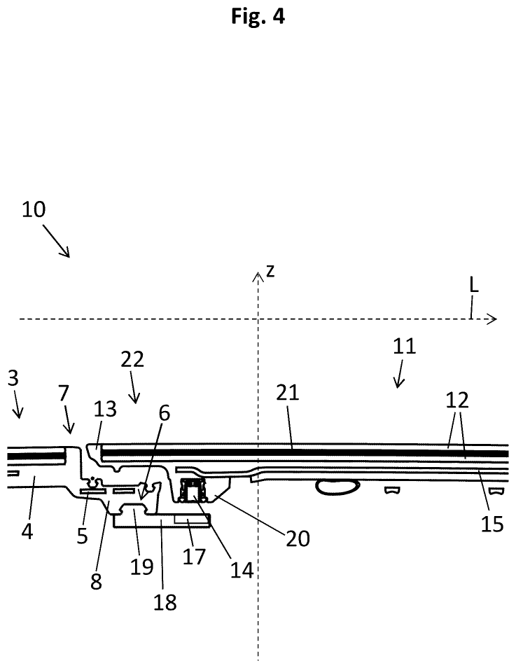

FIG. 4 shows another exemplary embodiment of the assembly 10, wherein the protrusion 20 of the foaming 13 has a clearance which is designed for receiving the magnetic element 14. The clearance is positioned, or formed as predefined, on the stationary roof element so as to correspond to the magnetic sensor 17. The magnetic element 14 is inserted, for example, in the clearance, and is reliably held in the clearance by means of a force-fit, for example by means of a clamping connection, by means of a materially integral fit, for example by an adhesive connection, and/or by means of a form-fit, preferably by means of a combination of at least two of those.

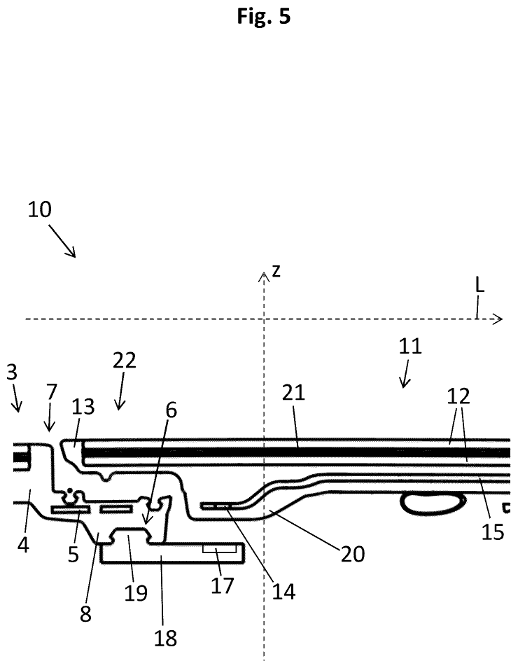

FIG. 5 shows another exemplary embodiment of the assembly 10, wherein the magnetic element 14 is disposed or integrated in the cover inner panel 15. The magnetic element 14 and the cover inner panel 15 can be formed conjointly as a ferromagnetic partner component.

### List of Reference Signs

1 Vehicle roof
2 Roof bodywork
3 Fixed glass element
4 foaming of the fixed glass element
5 Reinforcement element
6 Coupling opening
7 Front edge of the fixed glass element
8 Protrusion of the foaming of the fixed glass element
10 Assembly
11 Cover
12 Glass element
13 foaming of the cover
14 Magnetic element
15 Cover inner panel
17 Magnetic sensor/Hall sensor
18 Sensor bracket
19 Coupling element of the sensor bracket
20 Protrusion of the foaming of the cover
21 Lighting assembly
22 Rear edge of the cover
L Vehicle longitudinal axis

1. An assembly for a vehicle roof, comprising:
a cover having a lighting assembly, which is configured to form a movable roof element in the vehicle roof,
a foaming which is formed on the cover, and
a magnetic element and a magnetic sensor, which are configured to interact with one another,
wherein one of magnetic element and magnetic sensor is embedded in the foaming of the cover, and
the other of magnetic element and magnetic sensor is designed to be disposed on a stationary roof element of the vehicle roof in such a way that a movement of the cover relative to the stationary roof element is detectable by the magnetic sensor, and
the lighting assembly of the cover is actuatable as a function of the detected movement.

2. The assembly as claimed in claim 1, wherein the cover in terms of a vehicle longitudinal axis is configured to form a front roof element in the vehicle roof, and the stationary roof element in terms of the vehicle longitudinal axis is configured to form a rear roof element in the vehicle roof, wherein the magnetic element or the magnetic sensor is disposed on a rear edge of the cover, or is configured to be disposed on a front edge of the stationary roof element.

3. The assembly as claimed in claim 1, wherein one of magnetic element and magnetic sensor is configured to be disposed on a roof bodywork.

4. The assembly as claimed in claim 1, wherein one of magnetic element and magnetic sensor is configured to be disposed on a guide rail for the vehicle roof.

5. The assembly as claimed in claim 1, claims, wherein one of magnetic element and magnetic sensor within the foaming of the cover is disposed on a cover inner panel.

6. The assembly as claimed in claim 1, wherein one of magnetic element and magnetic sensor within the foaming of the cover is integrated into a cover inner panel.

7. The assembly as claimed in claim 1, wherein the foaming has a clearance which is designed to receive one of magnetic element and magnetic sensor.

8. The assembly as claimed in claim 7, wherein one of magnetic element and magnetic sensor is disposed in a force-fitting, form-fitting and/or materially integral manner in the clearance of the foaming.

9. The assembly as claimed in claim 1, wherein the cover comprises a position indication element which indicates a position of the magnetic element or of the magnetic sensor in the foaming of the cover.

10. The assembly as claimed in claim 1, wherein the magnetic sensor is designed as a Hall sensor.

11. A vehicle roof for a motor vehicle, comprising:
a stationary roof element which forms a roof bodywork of the vehicle roof or is coupled to a roof bodywork of the vehicle roof, and
an assembly as claimed in claim 1, which is coupled to the stationary roof element wherein the cover closes a roof opening in the vehicle roof in a predefined manner, or exposes the roof opening when required, and one of magnetic element and magnetic sensor within the foaming is coupled to the cover, and the other of magnetic element and magnetic sensor is coupled to the stationary roof element

12. The vehicle roof as claimed in claim 11, wherein the cover in terms of a vehicle longitudinal axis is configured to form a front roof element in the vehicle roof, and the stationary roof element in terms of the vehicle longitudinal axis is configured to form a rear roof element in the vehicle roof, wherein the magnetic element or the magnetic sensor is disposed on a rear edge of the cover, or is configured to be disposed on a front edge of the stationary roof element, and wherein the rear roof element has a foaming to which one of magnetic element and magnetic sensor is interchangeably coupled.

13. A method for producing an assembly for a vehicle roof, comprising:
providing a cover having a lighting assembly, which is configured to form a movable roof element in the vehicle roof,
providing a magnetic element and a magnetic sensor, which are configured to interact with one another, wherein one of magnetic element and magnetic sensor is configured to be foamed and to be coupled to the cover, and the other of magnetic element and magnetic sensor is configured to be coupled to a stationary roof element of the vehicle roof,
positioning one of magnetic element and magnetic sensor relative to the cover,
forming a foaming on the cover in such a way that one of magnetic element and magnetic sensor is embedded in the foaming, and a movement of the cover relative to the stationary roof element is detectable by the magnetic sensor, and the lighting assembly of the cover is actuatable as a function of the detected movement.

14. The method as claimed in claim 13, comprising:
providing the stationary roof element which forms a roof bodywork of the vehicle roof, or is configured to be coupled to a roof bodywork of the vehicle roof, and
coupling the other of magnetic element and magnetic sensor to the stationary roof element.

15. The method as claimed in claim 13, wherein forming a foaming on the cover comprises:
providing a foaming tool having a sensor which is configured to detect the presence of the magnetic element in a spaced-apart region,
positioning the magnetic element relative to the cover,
determining the presence of the magnetic element by means of the sensor of the foaming tool, and
foaming the magnetic element and the cover as a function of the determined presence of the magnetic element.

16. The method as claimed in claim 15, wherein the positioning of the magnetic element relative to the cover comprises:
providing a cover inner panel for the cover,
disposing the magnetic element at a predetermined position on the cover inner panel, and
positioning the cover inner panel with the magnetic element relative to the cover.

17. The method as claimed in claim 15, wherein the positioning of the magnetic element relative to the cover comprises:
providing a cover inner panel for the cover,
incorporating the magnetic element into the foaming tool at a predefined position,
incorporating the cover inner panel into the foaming tool,
moving the cover inner panel to the magnetic element and self-positioning the magnetic element on the cover inner panel as a function of a magnetic force of the magnetic element, and
positioning the cover inner panel with the magnetic element relative to the cover.
